(19) United States
(12) Patent Application Publication
(10) Pub. No.: US 2023/0084110 A1
(43) Pub. Date: Mar. 16, 2023

(54) SECURE COMPUTATION METHOD, SECURE COMPUTATION SYSTEM AND PROGRAM

(71) Applicant: NIPPON TELEGRAPH AND TELEPHONE CORPORATION, Tokyo (JP)

(72) Inventors: Yukihiro BANDO, Musashino-shi, Tokyo (JP); Takayuki NAKACHI, Musashino-shi, Tokyo (JP)

(73) Assignee: NIPPON TELEGRAPH AND TELEPHONE CORPORATION, Tokyo (JP)

(21) Appl. No.: 17/800,604

(22) PCT Filed: Jun. 22, 2020
(86) PCT No.: PCT/JP2020/024305

§ 371 Date: Aug. 18, 2022

(30) Foreign Application Priority Data
Feb. 21, 2020 (JP) PCT/JP2020/007193

(51) Int. Cl. H04L 9/06; H04L 9/14

(52) U.S. Cl. CPC H04L 9/0618; H04L 9/14

(57) ABSTRACT

One aspect of the present invention is a secure computation method including, acquiring a plurality of pieces of encrypted analysis target information being a plurality of pieces of encrypted information about an event to be analyzed, and analyzing, based on the plurality of pieces of the encrypted analysis target information, the event without decrypting the plurality of pieces of the encrypted analysis target information. In the secure computation method, encryption keys for the plurality of pieces of the encrypted analysis target information are unitary matrices, and at least one of the encryption keys for the plurality of pieces of the encrypted analysis target information is different from another of the encryption keys.

The present application claims priority based on PCT/JP2020/007193 filed internationally on Feb. 21, 2020, the contents of which are incorporated herein by reference.

### TECHNICAL FIELD

The present invention relates to a secure computation method, a secure computation system, and a program.

### BACKGROUND ART

In recent years, edge cloud computing has become rapidly prevalent as a computational resource for big data analysis (see NPL 1). Targets of analysis by edge cloud computing are highly diversified, ranging from media signals such as audio and video to economic data such as product transaction information and medical information such as clinical results, etc.

### CITATION LIST

### Non Patent Literature

NPL 1 “Edge Computing” Attracting Attention in the Age of IoT”, [online], NTT DATA, [Searched on Feb. 20, 2020], Internet <https://www.nttdata.com/jp/ja/data-insight/2018/1122/>

### SUMMARY OF THE INVENTION

### Technical Problem

However, users cannot freely handle all information on the cloud by edge cloud computing. For example, if information that may lead to personal identification of acquired data is handled by edge cloud computing, the use of the information may be restricted from the viewpoint of privacy protection. Examples of such information include information such as clinical test results, purchase history, travel routes, and the like. Such information is used by organization/institution that acquires the information in a closed manner.

Even when the use is restricted in this way, there is no problem with restricting the use of the information if the desired result can be obtained only from the available range of information. For example, for an organization that has a large number of users and can acquire information of a desired scale, there is no problem even if the information on the cloud is somewhat restricted.

However, there are cases where it is desired to analyze an event to be analyzed using information for which a sufficient number of data cannot be obtained at a single institution, such as clinical data at a medical institution. In such a case, if each clinical data is available only to specific organizations that are different from each other, it may not be possible to obtain sufficient analysis results.

As described above, until now, it has been difficult to achieve both high confidentiality of information and improvement of analysis accuracy of the event to be analyzed.

In view of the above circumstances, an object of the present invention is to provide a technique that achieves both high confidentiality of information and improvement of analysis accuracy of an event to be analyzed.

### Means for Solving the Problem

One aspect of the present invention is a secure computation method including, acquiring a plurality of pieces of encrypted analysis target information being a plurality of pieces of encrypted information about an event to be analyzed, and analyzing, based on the plurality of pieces of the encrypted analysis target information, the event without decrypting the plurality of pieces of the encrypted analysis target information. In the secure computation method, encryption keys for the plurality of pieces of the encrypted analysis target information are unitary matrices, and at least one of the encryption keys for the plurality of pieces of the encrypted analysis target information is different from another of the encryption keys.

### Effects of the Invention

According to the present invention, it is possible to achieve both high confidentiality of information and improvement of analysis accuracy of an event to be analyzed.

### BRIEF DESCRIPTION OF DRAWINGS

FIG. 1 is an explanatory diagram illustrating an outline of a secure computation system 100 according to an embodiment.

FIG. 2 is an explanatory diagram illustrating an example of a system configuration of the system configuration of the secure computation system 100 according to the embodiment.

FIG. 3 is a diagram illustrating an example of functional configuration of a control unit 20 included in a ciphertext generation apparatus 2 according to the embodiment.

FIG. 4 is a diagram illustrating an example of functional configuration of a control unit 10 according to the embodiment.

FIG. 5 is a flowchart illustrating an example of a flow of processing executed by the ciphertext generation apparatus 2 and a management apparatus 3 according to the embodiment.

FIG. 6 is a flowchart illustrating an example of a flow of processing executed by a secure computation apparatus 1 according to the embodiment.

FIG. 7 is a diagram illustrating an example of a functional configuration of a control unit 20a included in the ciphertext generation apparatus 2 according to a modified example.

FIG. 8 is a flowchart illustrating an example of a flow of processing for the execution of a confidentiality enhancement process by the ciphertext generation apparatus 2 in the modified example.

FIG. 9 is a flowchart illustrating an example of a flow of processing for the execution of an Elastic confidentiality enhancement process by the ciphertext generation apparatus 2 in the modified example.

### DESCRIPTION OF EMBODIMENTS

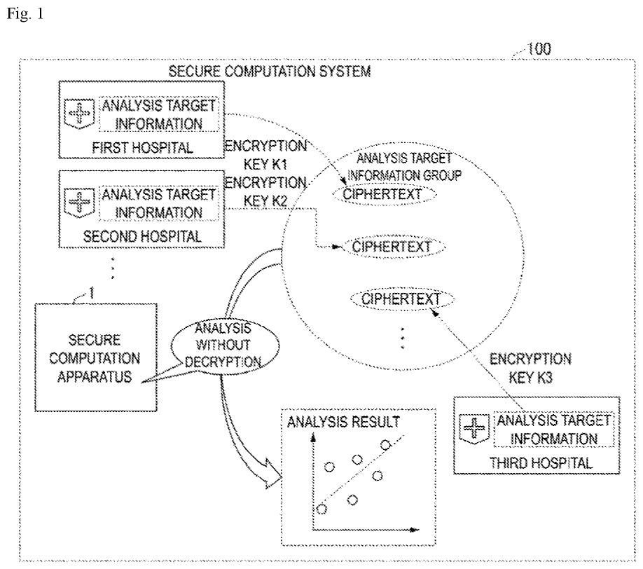

FIG. 1 is an explanatory diagram illustrating an outline of a secure computation system 100 according to an embodiment. The secure computation system 100 includes a secure computation apparatus 1. The secure computation apparatus 1 analyzes an event to be analyzed (hereinafter, referred to as “analysis target event”) by a method of regression analysis. Analyzing specifically means deriving a relationship between a result and a factor of an analysis target event. The method of regression analysis is, for example, a least absolute shrinkage and selection operator (LASSO). In LASSO, a solution is obtained using, for example, least angle regression (LARS) and coordinate descent algorithm (CDA).

The secure computation apparatus 1 executes regression analysis on a set of pieces of encrypted analysis target information (hereinafter, referred to as “analysis target information group”) without decrypting each pieces of the encrypted analysis target information. The encrypted analysis target information is ciphertext in which analysis target information being information about an analysis target event is encrypted in advance by random unitary transformation. One piece of analysis target information is information showing an example of a factor and result when an analysis target event occurs.

Random unitary transformation is a process of transforming an input by a random unitary matrix. A random unitary matrix is a unitary matrix in which the values of elements are randomly determined. The random unitary matrix is, for example, a matrix in which Gram-Schmidt orthogonalization is applied to a pseudo-random matrix.

The analysis target information group in FIG. 1 includes information obtained by encrypting the analysis target information acquired in a first hospital using an encryption key K1. The analysis target information group in FIG. 1 further includes information obtained by encrypting the analysis target information acquired in a second hospital using an encryption key K2. Moreover, the analysis target information group in FIG. 1 further includes information obtained by encrypting the information acquired in a third hospital using an encryption key K3. In this way, the analysis target information includes a plurality of pieces of information encrypted with different encryption keys. It is noted that not all encryption keys need to be different. However, for ease of explanation below, the secure computation apparatus 1 will be described by taking as an example a case where each pieces of analysis target information is encrypted by a different encryption key.

Here, the information acquired by hospitals including the first hospital, the second hospital, and the third hospital in FIG. 1 will be described by taking as an example a case where the analysis target event is a result of the onset of a disease to be analyzed.

If the analysis target event is the result of the onset of a disease to be analyzed, the analysis target information acquired by hospitals including the first hospital, the second hospital, and the third hospital is disease-related information. Here, the disease-related information is information indicating whether or not the disease to be analyzed has developed and information indicating each diagnosis result of a plurality of diagnoses made to the patient regarding the disease to be analyzed.

When the secure computation apparatus 1 analyzes the analysis target event, the secure computation apparatus 1 uses event result information and event factor information, the contents of which are represented by a vector. Here, the event result information and the event factor information are information included in the encrypted analysis target information. The event result information is information indicating whether the analysis target event has occurred, and is information encrypted by random unitary transformation. The event result information is, for example, information indicating whether the disease to be analyzed has developed, and is information encrypted by random unitary transformation.

The event factor information is information on the factors that cause the analysis target event, and is information encrypted by random unitary transformation. The event factor information is, for example, information that is the diagnosis result of each of a plurality of diagnoses made to the patient regarding the disease to be analyzed and is encrypted by random unitary transformation. Hereinafter, the vector indicating the event result information will be referred to as an observation vector. Hereinafter, the vector indicating the event factor information will be referred to as a feature vector. The secure computation apparatus 1 analyzes the analysis target event by executing an operation that reduces the difference between the observation vector and the linear sum of the plurality of feature vectors.

The reason why the secure computation apparatus 1 is able to analyze the analysis target event without decryption will be described later.

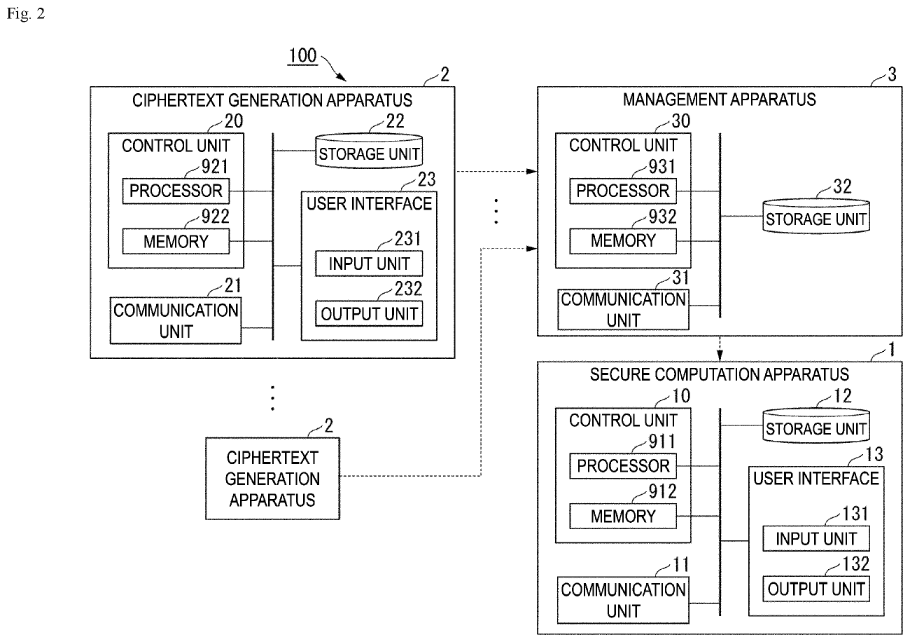

FIG. 2 is an explanatory diagram illustrating an example of a system configuration of the secure computation system 100 according to the embodiment. The secure computation system 100 further includes a plurality of ciphertext generation apparatuses 2 and a management apparatus 3 in addition to the secure computation apparatus 1.

The ciphertext generation apparatus 2 generates the encrypted analysis target information. Specifically, the ciphertext generation apparatus 2 first acquires the analysis target information. Next, the ciphertext generation apparatus 2 generates the encrypted analysis target information by encrypting the acquired analysis target information by random unitary transformation. In the example of FIG. 1, each of the hospitals including the first hospital, the second hospital, and the third hospital is provided with the ciphertext generation apparatus 2, and the user of each hospital operates the ciphertext generation apparatus 2 to generate encrypted analysis target information.

The ciphertext generation apparatus 2 includes a control unit 20 including a processor 921 such as a Central Processing Unit (CPU), and a memory 922, which are connected by a bus, and executes a program. The ciphertext generation apparatus 2 functions as an apparatus including the control unit 20, a communication unit 21, a storage unit 22, and a user interface 23 by executing a program. Although the hardware details of one of the ciphertext generation apparatuses 2 will be described with reference to FIG. 2, the other ciphertext generation apparatuses 2 illustrated in FIG. 2 also have the same functions.

More specifically, in the ciphertext generation apparatus 2, the processor 921 reads a program stored in the storage unit 22, and stores the read program in the memory 922. When the processor 921 executes the program stored in the memory 922, the ciphertext generation apparatus 2 functions as an apparatus including the control unit 20, the communication unit 21, the storage unit 22, and the user interface 23.

The control unit 20 controls the operation of each functional unit included in the ciphertext generation apparatus 2. The control unit 20 controls, for example, the operation of the communication unit 21. The control unit 20 controls, for example, the operation of the user interface 23. The control unit 20 acquires the analysis target information via, for example, the communication unit 21 or the user interface 23. The control unit 20 encrypts, for example, the analysis target information by random unitary transformation. The control unit 20 records, for example, the generated encrypted analysis target information in a storage unit 12.

The communication unit 21 is configured to include a communication interface for connecting the ciphertext generation apparatus 2 to an external apparatus. The communication unit 21 communicates with the external apparatus wirelessly or by wire via the communication interface. The external apparatus includes an apparatus for acquiring the analysis target information. An apparatus for measuring the analysis target information is, for example, a diagnostic apparatus such as an ultrasonic diagnostic apparatus. In such a case, the communication unit 21 acquires the analysis target information from, for example, an external apparatus in communication with the communication unit 21. The external apparatus includes the management apparatus 3. The communication unit 21 transmits the encrypted analysis target information to the management apparatus 3.

The storage unit 22 is configured using a storage device such as a magnetic hard disk device or a semiconductor storage device. The storage unit 22 stores various types of information related to the ciphertext generation apparatus 2. The storage unit 22 stores in advance, for example, a program for controlling the operation of each functional unit included in the ciphertext generation apparatus 2. The storage unit 22 stores, for example, the analysis target information. The storage unit 22 stores, for example, the encrypted analysis target information.

The user interface 23 includes an input unit 231 that receives input to the ciphertext generation apparatus 2 and an output unit 232 that displays various types of information about the ciphertext generation apparatus 2. The user interface 23 is, for example, a touch panel. The input unit 231 receives an input to the ciphertext generation apparatus 2. The input unit 231 is, for example, an input terminal such as a mouse, a keyboard, or a touch panel. The input unit 231 may be configured as an interface for connecting the input terminals to the ciphertext generation apparatus 2, for example. The input received by the input unit 231 is, for example, the analysis target information.

The output unit 232 is, for example, a display apparatus such as a liquid crystal display, an organic Electro Luminescence (EL) display, a touch panel, or the like. The output unit 232 may be configured as an interface for connecting the display apparatuses to the ciphertext generation apparatus 2, for example. The output unit 232 may be an audio output apparatus such as a speaker, for example. The information output by the output unit 232 is, for example, the information input to the input unit 231. The information output by the output unit 232 is, for example, information indicating an operation result of the input unit 231. Hereinafter, for the sake of simplicity, the ciphertext generation apparatus 2 will be described by taking as an example a case where the output unit 232 is a display apparatus.

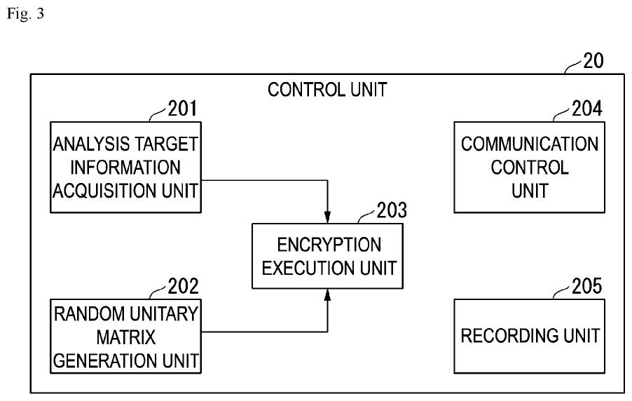

FIG. 3 is a diagram illustrating an example of functional configuration of the control unit 20 included in the ciphertext generation apparatus 2 according to the embodiment. The control unit 20 includes an analysis target information acquisition unit 201, a random unitary matrix generation unit 202, an encryption execution unit 203, a communication control unit 204, and a recording unit 205.

The analysis target information acquisition unit 201 acquires the analysis target information via the communication unit 21 or the input unit 231.

The random unitary matrix generation unit 202 generates random numbers and uses the generated random numbers to generate a random unitary matrix. Thus, the random unitary matrices generated by the random unitary matrix generation unit 202 at different timings are not necessarily the same.

A random unitary matrix generated by the random unitary matrix generation unit 202 is an encryption key for encrypting the analysis target information. Further, the random unitary matrices are generated by using random numbers, because of which at most of timings, at least one of the encryption keys generated by the plurality of ciphertext generation apparatuses 2 included in the secure computation system 100 is different from another of the encryption keys.

The encryption execution unit 203 generates the encrypted analysis target information by encrypting the analysis target information by using the random unitary matrix generated by the random unitary matrix generation unit 202.

The communication control unit 204 controls the operation of the communication unit 21. The communication control unit 204 controls the operation of the communication unit 21 to transmit, for example, the encrypted analysis target information to the management apparatus 3. The recording unit 205 records information in the storage unit 22. Description will be provided with reference to FIG. 2 again.

The management apparatus 3 manages the encrypted analysis target information transmitted by each of the ciphertext generation apparatuses 2 included in the secure computation system 100. Here, the management specifically includes receiving and storing the encrypted analysis target information transmitted by each of the ciphertext generation apparatuses 2. Further, the management specifically means outputting the stored encrypted analysis target information to the secure computation apparatus 1.

The management apparatus 3 includes a control unit 30 including a processor 931 such as a CPU, and a memory 932, which are connected by a bus, and executes a program. The management apparatus 3 functions as an apparatus including the control unit 30, a communication unit 31, and a storage unit 32 by executing the program.

More specifically, in the management apparatus 3, the processor 931 reads a program stored in the storage unit 32, and stores the read program in the memory 932. When the processor 931 executes the program stored in the memory 932, the management apparatus 3 functions as an apparatus including the control unit 30, the communication unit 31, and the storage unit 32.

The control unit 30 controls the operation of each functional unit included in the management apparatus 3. The control unit 30 controls, for example, the operation of the communication unit 31. The control unit 30 acquires the encrypted analysis target information from each of the ciphertext generation apparatuses 2 via, for example, the communication unit 31. The control unit 30 records, for example, the acquired encrypted analysis target information in the storage unit 32.

The communication unit 31 is configured to include a communication interface for connecting the management apparatus 3 to each of the ciphertext generation apparatuses 2 and the secure computation apparatus 1 included in the secure computation system 100. The communication unit 31 communicates with each of the ciphertext generation apparatuses 2 wirelessly or by wire via a communication interface. The communication unit 31 acquires the encrypted analysis target information from each of the ciphertext generation apparatuses 2 via, for example, the communication interface. The communication unit 31 communicates with the secure computation apparatus 1 wirelessly or by wire via a communication interface. The communication unit 31 transmits the encrypted analysis target information to the secure computation apparatus 1 via, for example, the communication interface.

The storage unit 32 is configured using a storage device such as a magnetic hard disk device or a semiconductor storage device. The storage unit 32 stores various types of information related to the management apparatus 3. The storage unit 32 stores in advance, for example, a program for controlling the operation of each functional unit included in the management apparatus 3. The storage unit 32 stores, for example, the encrypted analysis target information.

The secure computation apparatus 1 includes a control unit 10 including a processor 911 such as a CPU, and a memory 912, which are connected by a bus, and executes a program. The secure computation apparatus 1 functions as an apparatus including the control unit 10, a communication unit 11, the storage unit 12, and a user interface 13 by executing a program.

More specifically, in the secure computation apparatus 1, the processor 911 reads a program stored in the storage unit 12, and stores the read program in the memory 912. When the processor 911 executes the program stored in the memory 912, the secure computation apparatus 1 functions as an apparatus including the control unit 10, the communication unit 11, the storage unit 12, and the user interface 13.

The control unit 10 controls the operation of each functional unit included in the secure computation apparatus 1. The control unit 10 controls, for example, the operation of the communication unit 11. The control unit 10 acquires the encrypted analysis target information from the management apparatus 3 via, for example, the communication unit 11. The control unit 10 executes, for example, an analysis process. The analysis process is a process of analyzing an analysis target event using the encrypted analysis target information without decrypting the encrypted analysis target information. The control unit 20 records, for example, the analysis result of the analysis process in the storage unit 12. The control unit 10 controls, for example, the operation of the user interface 13. For example, the control unit 10 controls the operation of the user interface 13 and causes the output unit 132 to output the analysis result of the analysis process.

The communication unit 11 is configured to include a communication interface for connecting the secure computation apparatus 1 to an external apparatus. The external apparatus includes the management apparatus 3. The communication unit 11 acquires, for example, the encrypted analysis target information from the management apparatus 3. The external apparatus may include, for example, a printer that outputs the analysis result. In such a case, the communication unit 11 causes the printer to output the analysis result, for example.

The storage unit 12 is configured using a storage device such as a magnetic hard disk device or a semiconductor storage device. The storage unit 12 stores various types of information related to the secure computation apparatus 1. The storage unit 12 stores in advance, for example, a program for controlling the operation of each functional unit included in the secure computation apparatus 1. The storage unit 12 stores, for example, the encrypted analysis target information. The storage unit 12 stores, for example, the analysis result of the analysis process.

The user interface 13 includes an input unit 131 that receives input to the secure computation apparatus 1 and an output unit 132 that displays various types of information about the secure computation apparatus 1. The user interface 13 is, for example, a touch panel. The input unit 131 receives an input to the secure computation apparatus 1. The input unit 131 is, for example, an input terminal such as a mouse, a keyboard, or a touch panel. The input unit 131 may be configured as an interface for connecting the input terminals to the secure computation apparatus 1, for example. The input received by the input unit 131 is, for example, a user's operation on the secure computation apparatus 1.

The output unit 132 is, for example, a display apparatus such as a liquid crystal display, an organic EL display, a touch panel, or the like. The output unit 132 may be configured as an interface for connecting the display apparatuses to the secure computation apparatus 1, for example. The output unit 132 may be an audio output apparatus such as a speaker, for example. The information output by the output unit 132 is, for example, the analysis result of the analysis process. Hereinafter, for the sake of simplicity, the secure computation apparatus 1 will be described by taking as an example a case where the output unit 132 is a display apparatus.

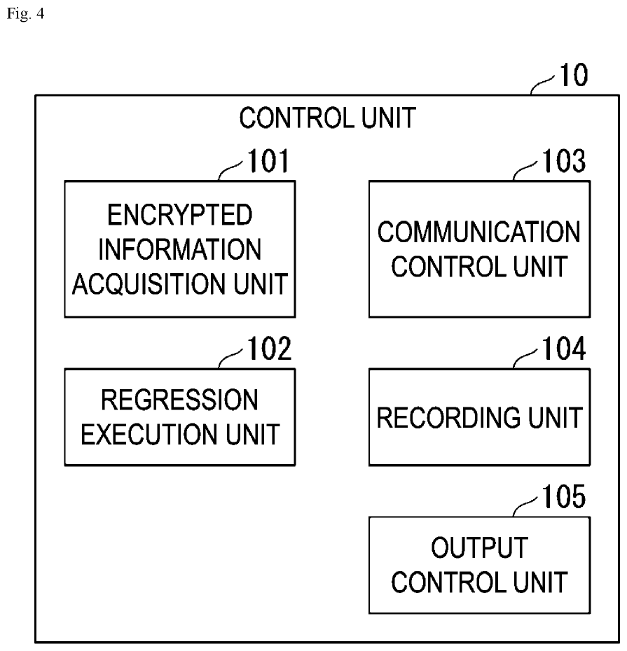

FIG. 4 is a diagram illustrating an example of functional configuration of the control unit 10 according to the embodiment. The control unit 10 includes an encrypted information acquisition unit 101, a regression execution unit 102, a communication control unit 103, a recording unit 104, and an output control unit 105.

The encrypted information acquisition unit 101 acquires pieces of the encrypted analysis target information. Each pieces of the encrypted analysis target information is encrypted by random unitary transformation, because of which the encryption keys for the pieces of the encrypted analysis target information acquired by the encrypted information acquisition unit 101 are not necessarily the same.

The regression execution unit 102 executes the regression process at a timing when a predetermined number of pieces of encrypted analysis target information is acquired. The regression process is a process in which the regression execution unit 102 executes regression analysis on a set of pieces of encrypted analysis target information without decrypting the pieces of the encrypted analysis target information. The reason why the regression execution unit 102 is able to execute the regression analysis without decrypting the encrypted analysis target information will be described later.

The communication control unit 103 controls the operation of the communication unit 11. The communication control unit 103 controls the operation of the communication unit 11 to acquire, for example, the encrypted analysis target information from the management apparatus 3.

The recording unit 104 records information in the storage unit 12. The recording unit 104 records, for example, the encrypted analysis target information acquired by the encrypted information acquisition unit 101 in the storage unit 12. The recording unit 104 records, for example, the analysis result by the regression execution unit 102 in the storage unit 12.

The output control unit 105 controls the operation of the output unit 132 to cause the output unit 132 to output information. The output control unit 105 controls the operation of the output unit 132, and causes, for example, the output unit 132 to output the analysis result by the regression execution unit 102.

Explanation That Regression Process Can Be Executed Without Decryption Here, the reason why the regression execution unit 102 is able to execute the regression analysis without decrypting the encrypted analysis target information will be described by taking as an example a case where the regression analysis method is LASSO using least angle regression (LARS) and the coordinate descent algorithm (CDA).

Firstly, LASSO will be described by taking as an example a case where the analysis target information is not encrypted. The case where the analysis target information is not encrypted corresponds to a case where the analysis target information is encrypted using a unit matrix instead of a random unitary matrix.

LASSO

Expressing an observation vector y by a linear sum of p number of feature vectors xⱼ will be considered. The observation vector y is defined by the Equation (1).

[Math. 1]

y=(y₀, . . . ,yₙ₋₁)^{T}∈ [symbol] ⁿ (1)

The feature vector xⱼ is defined by the Equation (2).

[Math. 2]

xⱼ=(x_{0,j}, . . . ,x_{n-1,j})^{T}∈ [symbol] ⁿ, (j=0, . . . ,p−1) (2)

Here, a weighting coefficient vector is defined. The weighting coefficient vector w is defined by the Equation (3). Hereinafter, wᵢ will be referred to as the weighting coefficient of the feature vector xⱼ.

[Math. 3]

w=(w₀, . . . ,wₚ₋₁)^{T}∈ [symbol] ^{p} (3)

In the method called LASSO, the weighting coefficient vector is calculated as a solution of a constrained minimization problem of the following Expression (4).

$$\begin{matrix}[ Math . 4 ] & \\ {min}_{w ∈ {ℝ}^{p}} \frac{1}{2} {‖ y - X w ‖}_{2}^{2} subject to {‖ w ‖}_{1} \leq θ & ( 4 )\end{matrix}$$

Here, X is a matrix having the feature vector xⱼ as the j-th column. Hereinafter, X will be referred to as a feature matrix. θ is called an adjustment parameter and is a value that plays a role in adjusting the sparsity of the solution. The above-described constrained minimization problem can be formulated as a minimization problem represented by the following Expression (5) using the method of Lagrange multipliers.

$$\begin{matrix}[ Math . 5 ] & \\ {min}_{w ∈ {ℝ}^{p}} L ( w ) , L ( w ) {=}^{Δ} \frac{1}{2} {‖ y - X w ‖}_{2}^{2} + λ {‖ w ‖}_{1} = \frac{1}{2} {\sum }_{i = 0}^{n - 1} {( {y}_{i} - {\sum }_{j = 0}^{p - 1} {x}_{i , j} {w}_{j} )}^{2} + λ {\sum }_{j = 0}^{p - 1} \vert {w}_{j} \vert & ( 5 )\end{matrix}$$

Here, λ is a Lagrange undetermined multiplier, which is a parameter determined with respect to the adjustment parameter θ. In the following discussion, for the sake of simplicity, it is assumed that the following Equations (6) and (7) are satisfied.

[Math. 6]

Σⱼ₌₀^{p-1}x_{i,j}=0 (6)

[Math. 7]

Σⱼ₌₀^{p-1}x_{i,j}²=1 (7)

CDA

Next, CDA will be described. In CDA (see Reference Literature 1), a method is adopted where the control target is limited to one variable, and the remaining variables are not changed in an evaluation function L(w) in the Expression (5).

Reference Literature 1: J. Friedman, et al., “Pathwise coordinate optimization” Annals of Applied Statics, vol. 1, no. 2, pp. 302-332, 2007

It is considered that the control target is defined as w_{d}, and the Expression (5) is expressed by dividing into terms that do not include w_{d} and terms that include w_{d}. Expressions (10) and (11) are derived from the following Equations (8) and (9), and thus, the evaluation function L(w) in the Expression (5) is represented by Equations (12) and (13).

$$\begin{matrix}[ Math . 8 ] & \\ {y}_{i} - {\sum }_{j = 0}^{p - 1} {x}_{i , j} {w}_{j} = {y}_{i} - {\sum }_{j \neq d}^{p - 1} {x}_{i , j} {w}_{j} - {x}_{i , d} {w}_{d} & ( 8 )\end{matrix}$$

$$\begin{matrix}[ Math . 9 ] & \\ λ {‖ w ‖}_{1} = λ \vert {w}_{d} \vert + λ {\sum }_{j \neq d}^{p - 1} \vert {w}_{j} \vert & ( 9 )\end{matrix}$$

$$\begin{matrix}[ Math . 10 ] & \\ {r}_{i , d} {=}^{Δ} {y}_{i} - {\sum }_{j \neq d}^{p - 1} {x}_{i , j} {w}_{j} & ( 10 )\end{matrix}$$

$$\begin{matrix}[ Math . 11 ] & \\ {c}_{d} {=}^{Δ} λ {\sum }_{j \neq d}^{p - 1} \vert {w}_{j} \vert & ( 11 )\end{matrix}$$

$$\begin{matrix}[ Math . 12 ] & \\ L ( w ) = L ( {w}_{d} , {w}_{\neq d} ) = \frac{1}{2} {\sum }_{i = 0}^{n - 1} {( {r}_{i , d} - {w}_{d} {x}_{i , d} )}^{2} + λ \vert {w}_{d} \vert + {c}_{d} & ( 12 )\end{matrix}$$

$$\begin{matrix}[ Math . 13 ] & \\ {w}_{\neq d} = {( {w}_{j} \vert j = 0 , … , p - 1 , j \neq d )}^{T} & ( 13 )\end{matrix}$$

When the control target of minimization is fixed to w_{d} in the Equation (12), the Expression 5 is expressed b the Expression (14).

$$\begin{matrix}[ Math . 14 ] & \\ {min}_{{w}_{d} ∈ ℝ} L ( {w}_{d} , {w}_{\neq d} ) & ( 14 )\end{matrix}$$

Thus, the optimum solution of the Expression (14) is determined as a solution represented by the following Equations (15), (16), (17), (18), and (19).

$$\begin{matrix}[ Math . 15 ] & \\ {w}_{d}^{*} = \frac{1}{{‖ {x}_{d} ‖}_{2}^{2}} sign ( {r}_{d}^{T} {x}_{d} ) {( {r}_{d}^{T} {x}_{d} - λ )}_{+} & ( 15 )\end{matrix}$$

$$\begin{matrix}[ Math . 16 ] & \\ {r}_{d} = {( {r}_{0 , d ,} … , {r}_{n - 1 , d} )}^{T} & ( 16 )\end{matrix}$$

$$\begin{matrix}[ Math . 17 ] & \\ {x}_{d} = {( {x}_{0 , d} , … , {x}_{n - 1 , d} )}^{T} & ( 17 )\end{matrix}$$

$$\begin{matrix}[ Math . 18 ] & \\ sign ( t ) = \{ \begin{matrix}+ 1 & ( t > 0 ) \\ - 1 & ( otherwise ) o\end{matrix} & ( 18 )\end{matrix}$$

$$\begin{matrix}[ Math . 19 ] & \\ {( t )}_{+} = \{ \begin{matrix}t & ( t > 0 ) \\ 0 & ( otherwise )\end{matrix} & ( 19 )\end{matrix}$$

The same process is repeated with d=0, 1, . . . , p−1, 0, 1, . . . until an iteration end condition is satisfied.

LARS

Prior to the explanation of the processing procedure of LARS (see Reference Literature 2), the variables used in the explanation are organized. The active set A is a subset of indexes {1, 2, . . . , p}. For the following explanation, X_{A} defined by the following Expression (20) is defined as a matrix based on the index specified by A and a matrix composed of X column vectors (feature vectors).

Reference Literature 2: B. Efron, T. Hastie, I. Johnstone, and R. Tibshirani, “Least angle regression,” Annals of Statistics, vol. 32, no. 2, pp. 407-499, 2004

[Math. 20]

[symbol]

[symbol]

( . . . sⱼxⱼ . . . )_{j∈} [symbol] (20)

Here, sⱼ is a sign of the correlation coefficient between xⱼ and the prediction residue described later, and takes a value of 1 or (−1). The left side symbols of Expressions (21) to (23) below are defined as the right side of Expressions (21) to (23).

[Math. 21]

[symbol]

[symbol]

[symbol]

(21)

[Math. 22]

A [symbol] ( [symbol] )^{-1/2} (22)

[Math. 23]

[symbol]

[symbol]

[symbol]

(23)

Here, |A| is the number of elements of a set A, and 1_{|A|} is an |A| dimension vector in which all the elements are 1. Note that the A on the left side of the Expression (22) is a coefficient for normalizing the L2 norm of δA to 1. Further, the complement of the set A is represented by A\hat{ }c. A\hat{ }c represents that c is a superscript for A. The following isometric vector is defined as an update direction of the estimation vector with respect to y.

[Math. 24]

u [symbol] [symbol] (24)

Note that normalization is performed as ∥u∥₂=1. As the update direction of the coefficient vector corresponding to the above-described estimation vector, the p-dimensional vector d having the following as the j-th element is defined.

$$\begin{matrix}[ Math . 25 ] & \\ {d}_{j} = \{ \begin{matrix}{{s}_{j} [ {δ}_{} ]}_{j} & ( j ∈ ) \\ 0 & ( otherwise )\end{matrix} & ( 25 )\end{matrix}$$

The Equation (25) means that dⱼ, when j is an element of set A, is a value obtained by multiplying sⱼ with the j-th element of the vector S_{A}. Further, the Equation (25) means that dⱼ, when j is not an element of set A, is 0.

In LARS, in the Expression (5), solutions are derived for all λ values. LARS estimates the estimation vector μ=Xw for y, step by step. The estimation vector in the k-th step (k=0,0 . . . , p−1) is represented by μ\hat{ }(k) and the coefficient vector is represented by w\hat{ }(k), and the estimation process is started from p\hat{ }(0)=0, w\hat{ }(0)=0. In the LARS estimation process, attention is paid to the correlation between the estimated residual value and each feature vector (called residual correlation). The residual correlation is represented by the following Equation (26).

[Math. 26]

c^{(k)}=X^{T}(y−μ^{(k)}) (26)

At this time, the index corresponding to the feature vector that maximizes the absolute value of the residual correlation is registered as the active set A.

$$\begin{matrix}[ Math . 27 ] & \\ = \{ j : \vert {c}_{j}^{( k )} = {C}^{( k )} \} , {C}^{( k )} = {max}_{j} \vert {c}_{j}^{( k )} \vert & ( 27 )\end{matrix}$$

That is, when the prediction error of the current estimation vector p\hat{ }(k) is decomposed into feature vector components, the maximum amount of the components is given by |A| number of feature vectors registered in the active set. Thus, the direction in which the amount of reduction in the prediction error can be maximized with respect to the amount of increase in the step width is the direction in which an equal angle is formed with all the feature vectors in the active set. In fact, the isometric vector defined by the Expression (24) indicates this direction. As shown in the following equation, the isometric vector u has the same inner product with each column vector of XA, and forms the same angle with each column vector of XA.

[Math. 28]

[symbol]

u= [symbol] (28)

A\hat{ }(k) and u\hat{ }(k) are calculated, based on j Expressions (20) to (24), for j that satisfies the Expression (29) below. In this case, sⱼ satisfies the following Equation (30).

[Math. 29]

j∈ [symbol] (29)

[Math. 30]

sⱼ=sign(cⱼ^{(k)}) (30)

The reason why the Expression (20) defines the column vector of X_{A} by multiplying the above-described sⱼ is that the correlation coefficient between the feature vectors in the active set and the prediction residue needs to be a positive value.

The estimation vector is updated in the direction of the isometric vector u\hat{ }(k) according to the following Equation (31).

[Math. 31]

μ^{(k+1)}=μ^{(k)}+γ^{(k)}u^{(k)} (31)

Here, if k=0, . . . , p−2, the step width γ\hat{ }(k) is set as follows, based on the residual correlation. As shown in the Equation (28), when the estimation vector is u\hat{ }(k), the absolute value of the residual correlation is maximized in the feature vectors in set A. However, when the estimation vector is updated in the u\hat{ }(k) direction, the absolute value of the corresponding residual correlation decreases, and when the step width reaches a predetermined size, the absolute value becomes equal to that of the feature vectors within A\hat{ }c. Thus, y\hat{ }(k) is determined as the upper limit of the step width at which the feature vectors in A can maximize the absolute value of the residual correlation, and the following equation is obtained.

$$\begin{matrix}[ Math . 32 ] & \\ {γ}^{( k )} = {{min}^{+}}_{j ∈ {c}^{}} \{ \frac{{C}^{( k )} - {c}_{j}^{( k )}}{{A}^{( k )} - {a}_{j}^{( k )}} , \frac{{C}^{( k )} + {c}_{j}^{( k )}}{{A}^{( k )} + {a}_{j}^{( k )}} \} & ( 32 )\end{matrix}$$

min+ is an operator that selects the minimum value from the selection candidates being positive. aⱼ\hat{ }(k) is the inner product of the j-th column vector of X and the isometric vector u\hat{ }(k). In the case of k=p−1, which corresponds to the final step, all p feature vectors are used, and thus the step width is determined based on the minimization of the square error, and the following equation is obtained.

$$\begin{matrix}[ Math . 33 ] & \\ {γ}^{( p - 1 )} = \frac{{C}^{( p - 1 )}}{{A}^{( p - 1 )}} & ( 33 )\end{matrix}$$

The coefficient vector corresponding to the estimation vector is updated according to the following equation from the relationship of μ\hat{ }(k)=Xw\hat{ }(k).

[Math. 34]

w^{(k+1)}=w^{(k)}+γ^{(k)}d^{(k)} (34)

The index corresponding to the above-described γ(k) is identified as

$$\begin{matrix}[ Math . 35 ] & \\ \tilde{j} = {{argmin}^{+}}_{j ∈ {c}^{}} \{ \frac{{C}^{( k )} - {c}_{j}^{( k )}}{{A}^{( k )} - {a}_{j}^{( k )}} , \frac{{C}^{( k )} + {c}_{j}^{( k )}}{{A}^{( k )} + {a}_{j}^{( k )}} \} & ( 35 )\end{matrix}$$

and the active set A and the maximum value of the correlation is updated as follows.

[Math. 36]

[symbol]

+ [symbol] {\tilde{j}} (36)

[Math. 37]

C^{(k+1)}=C^{(k)}−γ^{(k)}A^{(k)} (37)

The above processing is repeated until k=0, . . . , p−1. The coefficient vector obtained by the Equation (34) is the solution of the Expression (5) corresponding to the range of the adjustment parameter θ (the upper bound of the L1 norm of the coefficient vector). The set of solutions obtained in all steps is referred to as the path of the solution.

In the case of the method called LARS-LASSO, the method of updating the step width and the method of updating the active set are different from those described above.

First, the following values are defined.

$$\begin{matrix}[ Math . 38 ] & \\ {\tilde{γ}}^{( k )} = {min}_{- \frac{{w}_{j}^{( k )}}{{d}_{j}^{( k )}} > 0 , j ∈} \{ - \frac{{w}_{j}^{( k )}}{{d}_{j}^{( k )}} \} & ( 38 )\end{matrix}$$

If the element j of the set A does not satisfy the relationship shown by the following Equation (39), a sufficiently large value is assigned to γ_k tilde. γ_k tilde means the symbol on the left side of the Equation (38). Hereinafter, H tilde means the symbol H with the tilde symbol placed on the top of the symbol H. Based on γ_k tilde, the following adaptation processing is performed. In the case of y\hat{ }(k)<γ_k tilde, the update of the active set is as described above. On the other hand, when γ_k tilde is γ\hat{ }(k) or more, the γ\hat{ }(k) is overwritten with γ_k tilde, and the update processing of the estimation vector and the coefficient vector is performed according to Equations (31) and (34). Furthermore, the active set A is updated as follows.

[Math. 39]

[symbol]

= [symbol] −{\tilde{j}} (39)

In this way, regression analysis is executed on the unencrypted analysis target information by LASSO using LARS and CDA. Next, LASSO will be described by taking as an example a case where the analysis target information is encrypted. First of all, the concealed coordinate algorithm will be described.

Concealed Coordinate Descent Algorithm

The solution of the Expression (5) is determined by CDA for the information subjected to transformation by the random unitary matrix Qp (random unitary transformation). To prepare for the discussion below, the random unitary transformation of each pieces of information is defined as follows. Hereinafter, the concealed information will be represented by a symbol with a superscript hat. For example, the concealed information y is expressed as the left side of the following Expression (40), and is expressed as y hat in the text.

[Math. 40]

ŷ [symbol] Qₚy (40)

[Math. 41]

\hat{X} [symbol] QₚX (41)

[Math. 42]

\hat{x} [symbol] Qₚxⱼ (42)

The relationship of the following Equation (43) is also satisfied.

$$\begin{matrix}[ Math . 43 ] & \\ \begin{matrix}\hat{X} = {Q}_{p} X \\ = {Q}_{p} ( {x}_{0} , … , {x}_{p} ) \\ = ( {Q}_{p} {x}_{0} , … , {Q}_{p} {x}_{p} ) \\ = ( {\hat{x}}_{0} , … , {\hat{x}}_{p} )\end{matrix} & ( 43 )\end{matrix}$$

Here, what should be solved is the minimization problem of the following expression.

$$\begin{matrix}[ Math . 44 ] & \\ {min}_{{\hat{w}}_{d} ∈ ℝ} L ( {\hat{w}}_{d} , {\hat{w}}_{\neq d} ) & ( 44 )\end{matrix}$$

$$\begin{matrix}[ Math . 45 ] & \\ L ( {\hat{w}}_{d} , {\hat{w}}_{\neq d} ) = \frac{1}{2} {\sum }_{i = 0}^{n - 1} {( {\hat{r}}_{i , d} - {\hat{w}}_{d} {\hat{x}}_{i , d} )}^{2} + λ \vert {\hat{w}}_{d} \vert + {\hat{c}}_{d} & ( 45 )\end{matrix}$$

$$\begin{matrix}[ Math . 46 ] & \\ {\hat{r}}_{i , d} {=}^{Δ} {\hat{y}}_{i} - {\sum }_{j \neq d}^{p - 1} {\hat{x}}_{i , j} {\hat{w}}_{j} & ( 46 )\end{matrix}$$

$$\begin{matrix}[ Math . 47 ] & \\ {\hat{c}}_{d} {=}^{Δ} λ {\sum }_{j \neq d}^{p - 1} {\hat{w}}_{j} & ( 47 )\end{matrix}$$

The optimum solution of wd hat in the Expression (44) is obtained by the following equation as in the Equation (15).

$$\begin{matrix}[ Math . 48 ] & \\ {\hat{w}}_{d}^{*} = \frac{1}{{‖ {\hat{x}}_{d} ‖}_{2}^{2}} sign ( {\hat{r}}_{d}^{T} {\hat{x}}_{d} ) {( {\hat{r}}_{d}^{T} {\hat{x}}_{d} - λ )}_{+} & ( 48 )\end{matrix}$$

In fact, the left side of the Equation (48) is equivalent to the left side of the Equation (15). Next, the concealed LARS will be described.

Concealed LARS

Determining the solution of the Expression (5) by LARS for the information (the Equations (49) and (50), and the Expression (42) below) subjected to transformation by the random unitary matrix Qp (random unitary transformation) will be considered.

[Math. 49]

ŷ^{(k)}=Qₚ^{(k)}y^{(k)} (49)

[Math. 50]

\hat{X}^{(k)}=Qₚ^{(k)}X^{(k)} (50)

The meanings of the Equations (49) and (50) will be described. The Equations (49) and (50) are specifically equations that are derived in consideration of the situation where random unitary transformation is performed separately at a plurality of locations. The number of locations is represented by K, the observation vector and feature vector acquired at the k-th location (k=0, . . . , K−1) are represented by y\hat{ }(k) and X\hat{ }(k), respectively, and the random unitary matrix used in the random unitary transformation is represented by Qp\hat{ }(k). In this case, the information obtained by encryption at the k-th location is the information on the left side of the Equation (49) and the information on the left side of the Equation (50). Note that y\hat{ }(k), X\hat{ }(k), and Qp\hat{ }(k) satisfy the following relationships, respectively.

[Math. 51]

y^{(k)}∈ [symbol] ⁿ^{ₖ} (51)

[Math. 52]

X^{(k)}∈ [symbol] ⁿ^{ₖ}^{×p}^{ₖ} (52)

[Math. 53]

Qₚ^{(k)}∈ [symbol] ⁿ^{ₖ}^{×n}^{ₖ} (53)

Determining the solution of the Expression (5) by LARS for the information subjected to transformation by the random unitary matrix Qp (random unitary transformation) refers to performing a solving process where instead of y hat, X hat, and xⱼ hat, Qₚy, QₚX, Qₚxⱼ are used as the input to LARS.

In the solving process, the following matrix or the like composed of the column vectors (feature vectors) of X hat, based on the index specified by the active set A, is used.

[Math. 54]

[symbol]

[symbol]

( . . . ŝⱼ\hat{x}ⱼ . . . )j∈ [symbol] (54)

[Math. 55]

[symbol]

[symbol]

[symbol]

(55)

[Math. 56]

[symbol]

[symbol]

[symbol]

(56)

[Math. 57]

[symbol]

[symbol]

[symbol]

(57)

Here, sⱼ hat is the symbol of the j-th element of the correlation vector, and satisfies the following Equation (58).

[Math. 58]

ŝⱼ=sign(ĉⱼ^{(k)}) (58)

At this time, for the information following the random unitary transformation defined by the Equations (49) and (50) and the Expression (42), the path of the solution determined by the Equation (34) is equivalent to the path of the solution determined for the signal prior to the random unitary transformation.

Described next is the fact that LASSO is capable of analyzing the analysis target without decrypting the information encrypted by the random unitary matrix.

Distributed Concealment

The situation described above will be considered again in relation to Equations (49) and (50). That is, a situation where random unitary transformation is performed individually for information at a plurality of locations will be considered. The number of locations is represented by K, the observation vector and feature vector acquired at the k-th location (k=0, . . . , K−1) are represented by y\hat{ }(k) and X\hat{ }(k), respectively, and the random unitary matrix used in the random unitary transformation is represented by Qp\hat{ }(k). At this time, the information obtained by encryption at the k-th location is the information on the left side of the Equation (49) and the information on the left side of the Equation (50).

Next, the information encrypted at each location is aggregated. To analyze the aggregated information, a vector y\hat{ }(0:K−1) hat in which the y\hat{ }(k) hat is concatenated in an ascending order in the row direction with respect to k is acquired. Further, to analyze the aggregated information, the matrix X\hat{ }(0:K−1) hat in which the X\hat{ }(k) hat is concatenated in an ascending order in the row direction with respect to k is acquired.

The vector y\hat{ }(0:K−1) hat satisfies the relationship shown in the following Expression (59). The left side of the Expression (59) is the vector y\hat{ }(0:K−1) hat.

[Math. 59]

ŷ^{(0:K-1)}∈ [symbol] ^{Kn}^{ₖ} (59)

The matrix X\hat{ }(0:K−1) hat satisfies the relationship shown in the following Expression (60). The left side of the Expression (60) is the matrix X\hat{ }(0:K−1) hat.

[Math. 60]

\hat{X}^{(0:K-1)}∈ [symbol] ^{Kn}^{ₖ}^{×n}^{ₖ} (60)

The knₖ+j-th element of the y\hat{ }(0:K−1) hat is the j-th element of the y\hat{ }(k) hat. The knₖ+j-th row of the X\hat{ }(0:K−1) hat is the j-th row vector of the X\hat{ }(k) hat. For the following discussion, the vector and matrix obtained by concatenating y\hat{ }(k) and X\hat{ }(k) in an ascending order in the row direction with respect to k are y\hat{ }(0:K−1) and X\hat{ }(0:K−1), respectively. y\hat{ }(0:K−1) satisfies the relationship of the following Expression (61), and X\hat{ }(0:K−1) satisfies the relationship of the following Expression (62).

[Math. 61]

y^{(0:K-1)}∈ [symbol] ^{Kn}^{ₖ} (61)

[Math. 62]

X^{(0:K-1)}∈ [symbol] ^{Kn}^{ₖ}^{×n}^{ₖ} (62)

The relationship between the y\hat{ }(0:K−1) hat and y\hat{ }(0:K−1) is expressed by the following Equation (63).

[Math. 63]

ŷ^{(0:K-1)}=Qₚ^{(0:K-1)}y^{(0:K-1)} (63)

The relationship between the X\hat{ }(0:K−1) hat and X\hat{ }(0:K−1) is expressed by the following Equation (64).

[Math. 64]

\hat{X}^{(0:K-1)}=Qₚ^{(0:K-1)}X^{(0:K-1)} (64)

At this time, Qₚ\hat{ }(0:K−1) is configured as a block diagonal matrix, as shown in the following Equation (65).

$$\begin{matrix}[ Math . 65 ] & \\ {Q}_{p}^{( 0 : K - 1 )} = ( \begin{matrix}{Q}_{p}^{( 0 )} & & & & 0 \\ & ⋱ & & & \\ & & {Q}_{p}^{( k )} & & \\ & & & ⋱ & \\ 0 & & & & {Q}_{p}^{( K - 1 )}\end{matrix} ) & ( 65 )\end{matrix}$$

As described above, Qₚ\hat{ }(0:K−1) is a block diagonal matrix having the unitary matrix Qₚ\hat{ }(k) as a diagonal element.

At this time, Qₚ\hat{ }(k), which is a block diagonal element matrix, is a unitary matrix, and thus, it can be seen that the relationship of the Equation (66) below is derived, and Qₚ\hat{ }(0:K−1) is a unitary matrix.

[Math. 66]

(Qₚ^{(0:K-1)})^{T}Qₚ^{(0:K-1)}=Qₚ^{(0:K-1)}(Qₚ^{(0:K-1)})^{T} (66)

The left side and the right side of the Equation (66) are unit matrices, respectively. As described above, the encrypted information obtained by the above-described aggregation can be said to be a random unitary transformation of the information prior to encryption. Thus, it can be seen that the integrity of the Lasso solution that holds for random unitary transformation also holds for distributed concealment.

From the discussions so far, it can be seen that LASSO is capable of analyzing the analysis target without decrypting the information encrypted by the random unitary matrix.

This ends the explanation of the reason why the regression execution unit 102 is able to execute the regression analysis without decrypting the encrypted analysis target information.

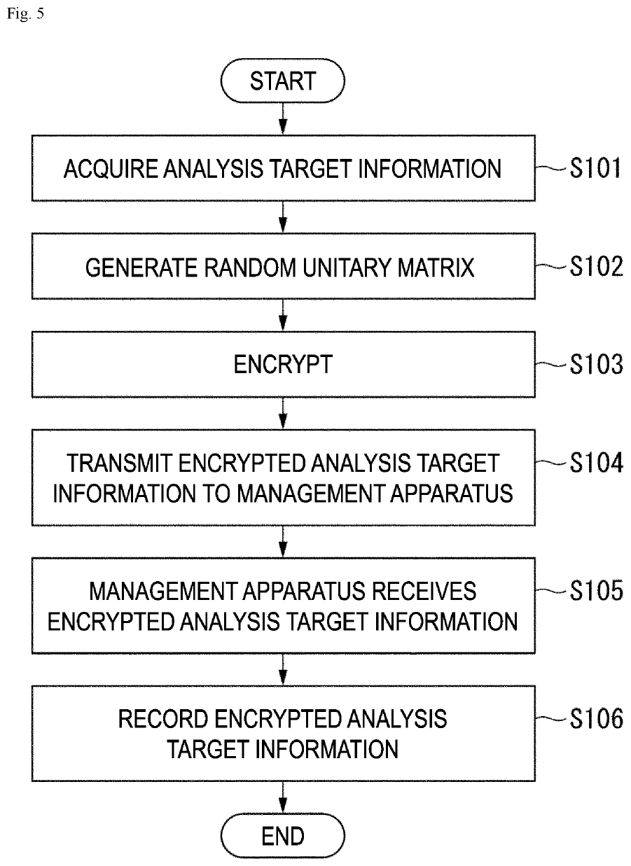

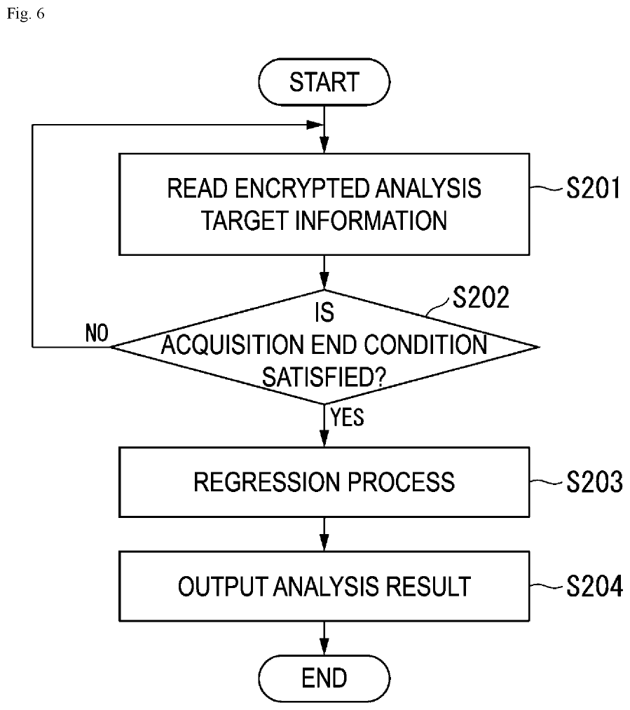

Hereinafter, an example of the flow of processing executed by the ciphertext generation apparatus 2 and the management apparatus 3, and an example of the flow of processing executed by the secure computation apparatus 1 will be described, with reference to FIGS. 5 and 6, by taking as an example a case where the secure computation system 100 includes K number (K is a natural number) of ciphertext generation apparatuses 2.

FIG. 5 is a flowchart illustrating an example of the flow of processing executed by the ciphertext generation apparatus 2 and the management apparatus 3 according to the embodiment.

The analysis target information acquisition unit 201 of each of the ciphertext generation apparatuses 2 acquires the analysis target information via the communication unit 21 or the input unit 231 (step S101). Next, the random unitary matrix generation unit 202 generates a random unitary matrix (step S102). Specifically, each of the ciphertext generation apparatuses 2 generates a pseudo-random number matrix, and by performing Gram-Schmidt orthogonalization on the generated pseudo-random number matrix, a matrix in which each column vector is orthogonal is generated. The matrix thus generated is a random unitary matrix.

After step S102, the encryption execution unit 203 encrypts the analysis target information by the random unitary matrix generated in step S102 (step S103). Specifically, the encryption execution unit 203 of each of the ciphertext generation apparatuses 2 encrypts the observation vectors and the feature vectors by random unitary transformation. For example, the y\hat{ }(k) hat and the X\hat{ }(k) hat are acquired, based on the Equations (49) and (50), at the k-th location (k is an integer that is 0 or more and K−1 or less). The k-th location is the k-th ciphertext generation apparatus 2 which is numbered according to a predetermined rule and is one of the K number of ciphertext generation apparatuses 2 included in the secure computation system 100. The information generated by the processing in step S103 is the encrypted analysis target information.

After step S103, the communication control unit 204 transmits the encrypted analysis target information to the management apparatus 3 via the communication unit 21 (step S104). Next, the control unit 30 included in the management apparatus 3 receives the encrypted analysis target information transmitted in step S104 via the communication unit 31 (step S105). Next, the control unit 30 records the encrypted analysis target information received in step S105 in the storage unit 32 (step S106).

FIG. 6 is a flowchart illustrating an example of the flow of processing executed by the secure computation apparatus 1 according to the embodiment.

The encrypted information acquisition unit 101 acquires the encrypted analysis target information stored in the storage unit 32 of the management apparatus 3 (step S201). Specifically, the processing in step S201 is a process in which the encrypted information acquisition unit 101 reads out the encrypted analysis target information stored in the storage unit 32 of the management apparatus 3. After step S201, the regression execution unit 102 determines whether an acquisition end condition is satisfied (step S202). The acquisition end condition is an end condition of the process of acquiring the encrypted analysis target information (that is, the processing in step S201). The acquisition end condition is, for example, a condition that a predetermined number of pieces of encrypted analysis target information has been acquired. If the acquisition end condition is not satisfied (step S202: NO), the processing returns to step S201.

On the other hand, if the acquisition end condition is satisfied (step S202: YES), the regression execution unit 102 executes the regression process (step S203). In the regression process, the regression execution unit 102 first aggregates all the acquired concealed observation vectors. The concealed observation vectors are observation vectors encrypted by the processing in step S103. In the regression process, the regression execution unit 102 then concatenates all the acquired concealed observation vectors in the row direction to acquire the y\hat{ }(0:K−1) hat. Hereinafter, the matrix resulting from the concatenation of the concealed observation vectors will be referred to as an aggregate concealed observation matrix.

In the regression process, the regression execution unit 102 then aggregates all the acquired concealed feature matrices. The concealed feature matrices are feature matrices encrypted by the processing in step S103. Next, the regression execution unit 102 concatenates all the acquired concealed feature matrices in the row direction to acquire the X\hat{ }(0:K−1) hat. Hereinafter, the matrix resulting from the concatenation of the concealed feature matrices will be referred to as an aggregate concealed feature matrix.

In the regression process, the regression execution unit 102 then performs the following iterative processing on d=0, . . . , p−1 until a predetermined convergence condition is satisfied. Hereinafter, as a specific example of the iterative processing, an iterative processing using a concealed CDA will be described.

In the iterative processing, the regression execution unit 102 sets the i-th component of the y\hat{ }(0:K−1) hat as the y, hat and the i, j-th components of the X\hat{ }(0:K−1) hat as the x_{i,j} hat, and calculates the r_{i, d} hat according to the Expressions (10) and (11). Note that i and j are natural numbers.

Next, in the iterative processing, the regression execution unit 102 sets, as the r_{d} hat, the vector in which the i-th component is the r_{i, d} hat, and sets, as the x_{d} hat, the vector in which the i-th component is the x_{i, d} hat, and calculates the w_{d}\hat{ }* hat according to the Equation (15). The w_{d}\hat{ }* hat is a symbol on the left side of the Equation (15). A predetermined convergence condition is, for example, a condition that an amount of update of the w_{d}\hat{ }* hat is equal to or less than a threshold value.

After step S203, the output control unit 105 controls the operation of the output unit 132 to cause the output unit 132 to output the analysis result being the result of the processing in step S203 (step S204).

In the iterative processing, a concealed LARS may be used instead of the concealed CDA.

The secure computation system 100 according to the embodiment thus configured encrypts the analysis target information by a random unitary matrix. In the analysis using the analysis target information encrypted by the random unitary matrix, the encrypted analysis target information does not have to be decrypted. Thus, the secure computation system 100 can achieve both high confidentiality of information and improvement of analysis accuracy of the event to be analyzed.

### Modified Example

When the secure computation system 100 generates the encrypted analysis target information using the analysis target information, the size of the information may be increased. In such a case, as compared to the case when the size of the information is not increased, the key space can be expanded, which enables the secure computation system 100 to enhance the confidentiality of the analysis target information. Hereinafter, the process of enhancing the confidentiality of the analysis target information by increasing the size of the information when generating the encrypted analysis target information using the analysis target information will be referred to as the confidentiality enhancement process. The confidentiality enhancement process will be explained mathematically.

Confidentiality Enhancement Process

For the sake of simplicity, the confidentiality enhancement process will be described by taking as an example a case where the size of the random unitary matrix Q_{p, n tilde} is n tilde rows by n tilde columns. n tilde is a natural number. The random unitary matrix Q_{p, n tilde} satisfies the relationship shown in the following Expression (67).

[Math. 67]

Q_{p,ñ}∈ [symbol] ^{ñ×ñ2} (67)

The random unitary matrix Q_{p, n tilde} is the symbol on the left side of the Expression (67). When the random unitary matrix Q_{p, n tilde} is used for encryption, the concealed observation vector y tilde being the observation vector y after encryption, and the concealed feature matrix X tilde being the feature matrix X after encryption are represented by the following Equations (68) and (70) and Expressions (69) and (71).

[Math. 68]

\tilde{y}=Q_{p,ñ}Sy+ψ (68)

[Math. 69]

\tilde{y}∈ [symbol] ^{ñ} (69)

[Math. 70]

\tilde{X}=Q_{p,ñ}SX (70)

[Math. 71]

\tilde{X}∈ [symbol] ^{ñ×ñ} (71)

S is a map that extends the dimension of the vector from n to n tilde (n is a natural number). S satisfies the following Expression (72).

[Math. 72]

S∈ [symbol] ^{ñ×ñ} (72)

Further, ψ is set as an n tilde dimensional vector satisfying the following Expression (73).

[Math. 73]

Q_{p,ñ}^{T}ψ=0ₙ (73)

Here, Oₙ being the right side of the Expression (73) is an n-dimensional vector, where all elements are 0. That is, ψ is an n-dimensional vector orthogonal to the column vector of Q_{p, n tilde}.

Hereinafter, a method for setting a map S and ψ will be described. The map S is set as a matrix that satisfies the condition that elements of the matrix take a value of 0 or 1, the condition that the sum of the elements of each column is 1, and the condition that the sum of the elements of each row is 1 or 0. Thus, each column of the map S contains only one element being 1 and the other elements are 0. Further, the row that takes 1 in each column of the map S is different for each column. As a result of the transformation Sy using the S, an n tilde dimensional vector is obtained in which n out of n tilde elements are the same as the elements of y and the remaining elements are 0.

Next, the method for setting ψ will be described. ψ is configured using the column vectors of Q_{p,n tilde}. Hereinafter, the elements of the map S in row i and column j (i=1, . . . , n tilde) (j=1, . . . , n) will be represented as si,j. Further, in the j column of the map S, the index of the row of the element taking 1 is represented as i(j) tilde.

In this case, Q_{p, n tilde}S is a matrix consisting of n number of column vectors. The n number of column vectors are the i(j) tilde-th column vectors (j=1, . . . , n) of Q_{p, n tilde}. Of the column vectors of Q_{p, n tilde}, there are (n tilde−n) number of column vectors not included in Q_{p, n tilde}S. Hereinafter, the (n tilde−n) number of column vectors will be referred to as the complement column vectors of Q_{p, n tilde}S.

Q_{p, n tilde} is a unitary matrix, thus, the complement column vectors of Q_{p, n tilde}S are orthogonal to the column vectors of Q_{p, n tilde}S. Thus, by setting any one of the complement column vectors of Q_{p, n tilde}S, or the linear sum of the complement column vectors of Q_{p, n tilde}S as ψ, the condition represented by the Expression (73) being the condition required of ψ can be satisfied.

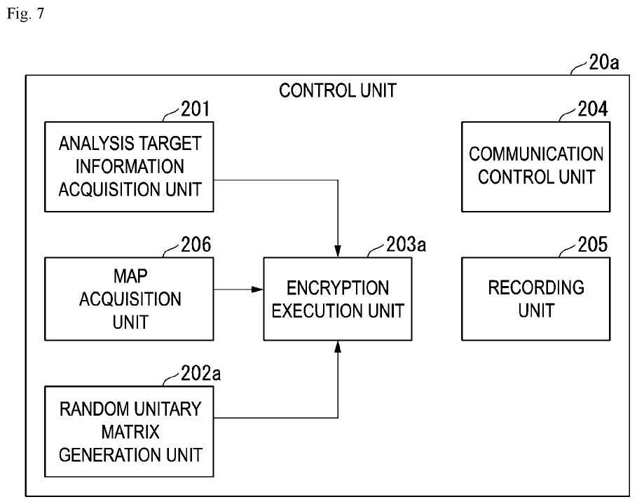

FIG. 7 is a diagram illustrating an example of functional configuration of the control unit 20 (hereinafter, referred to as “control unit 20a”) included in the ciphertext generation apparatus 2 according to the modified example. The control unit 20a differs from the control unit 20 in that the control unit 20a includes a map acquisition unit 206, a random unitary matrix generation unit 202a instead of the random unitary matrix generation unit 202, and an encryption execution unit 203a instead of the encryption execution unit 203. Hereinafter, the same reference signs as those in FIG. 3 will be applied to components that have similar functions as those in the control unit 20, and description thereof will be omitted.

The map acquisition unit 206 executes a map acquisition process. The map acquisition unit 206 generates the map S by executing the map acquisition process.

The map acquisition process will be specifically described. In the map acquisition process, the map acquisition unit 206 first performs a process of setting the map S to a zero matrix. Information indicating the dimensions of the observation vectors after transformation by the map S (hereinafter, referred to as “extended dimension information”) is stored in advance in the storage unit 22.

In the map acquisition process, the map acquisition unit 206 then generates a random number. In the map acquisition process, the map acquisition unit 206 then, based on the generated random number, generates an integer that is 1 or more and n tilde or less, and assigns the integer to an auxiliary variable i₁. The auxiliary variable i₁ is an auxiliary variable used to specify a column of the map acquisition unit 206 in the map acquisition process. In the map acquisition process, the map acquisition unit 206 then sets the element of the first column i₁ row of the map S to 1.

In the map acquisition process, the map acquisition unit 206 then generates a random number. In the map acquisition process, the map acquisition unit 206 then, based on the generated random number, generates an integer that is 1 or more and n tilde or less, and is not identical to i₁, and assigns the integer to an auxiliary variable i₂. The auxiliary variable i₂ is an auxiliary variable used to specify a column of the map S in the map acquisition process. In the map acquisition process, the map acquisition unit 206 then sets the element of the second column i₂ row of the map S to 1.

In the map acquisition process, the map acquisition unit 206 then generates a random number. In the map acquisition process, the map acquisition unit 206 then, based on the generated random number, generates an integer that is 1 or more and n tilde or less, and is not identical to i₁ and i₂, and assigns the integer to an auxiliary variable i₃. The auxiliary variable i₃ is an auxiliary variable used to specify a column of the map S in the map acquisition process. In the map acquisition process, the map acquisition unit 206 then sets the element of the third column i₃ row of the map S to 1.

Hereinafter, the same processing is executed for all the columns of the map S. Specifically, for each column of the map S, a process of setting, to 1, an element of a row which is one of the rows determined by the random numbers and in which all elements are 0 is executed.

The random unitary matrix generation unit 202a acquires a random unitary matrix in which the number of rows and the number of columns are the same as the dimension of the observation vector after transformation by the map S. That is, the number of rows and the number of columns of the random unitary matrix generation unit 202a are equal to the number of dimensions indicated by the extended dimension information.

The encryption execution unit 203a encrypts the observation vectors and the feature vectors using the map S and the random unitary matrix.

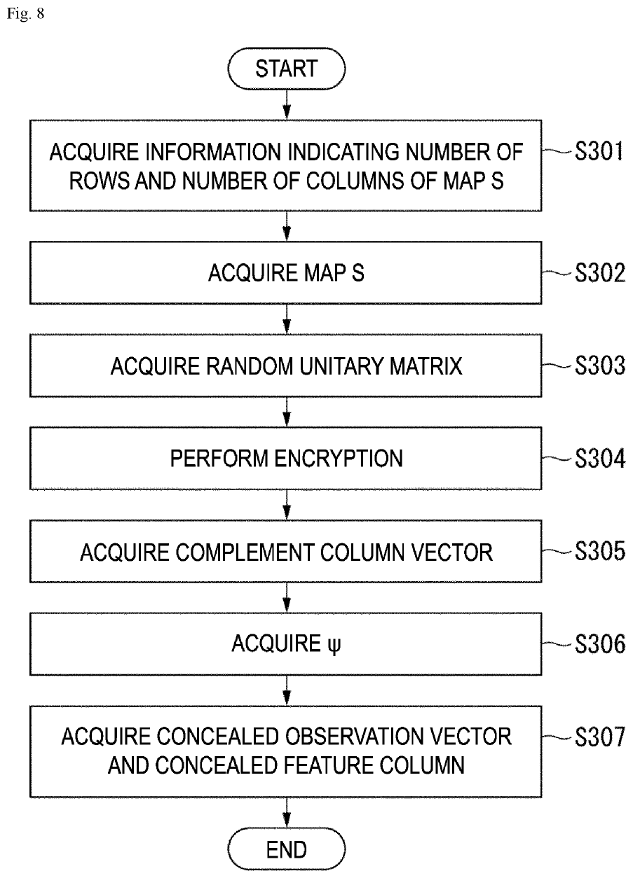

Hereinafter, an example of the flow of the confidentiality enhancement process executed by the ciphertext generation apparatus 2 in the modified example will be described, with reference to FIG. 8, by taking as an example a case where the secure computation system 100 includes K number (K is a natural number) of ciphertext generation apparatuses 2. Hereinafter, for the sake of simplicity, an example of the flow of the confidentiality enhancement process will be described by taking as an example a case where the dimension of the observation vector after extension by the map S is n tilde.

FIG. 8 is a flowchart illustrating an example of a flow of processing for the execution of a confidentiality enhancement process by the ciphertext generation apparatus 2 in the modified example.

The map acquisition unit 206 acquires information indicating the dimension n tilde after extension (step S301). Specifically, the processing in step S301 is a process in which the map acquisition unit 206 reads out the extended dimension information stored in the storage unit 22 in advance.

After step S301, the map acquisition unit 206 acquires the map S by executing the map acquisition process (step S302). The processing in step S302 is executed to improve the encryption strength of the observation vectors and the feature vectors encrypted by the processing in step S304 described later.

After step S302, the random unitary matrix generation unit 202a generates a random unitary matrix having the number of rows and the number of columns indicated by the extended dimension information (step S303). The random unitary matrix having the number of rows and the number of columns indicated by the extended dimension information is specifically, the random unitary matrix Q_{p, n tilde} having n tilde rows and n tilde columns. In the processing in step S303, the random unitary matrix generation unit 202a specifically generates a pseudo-random number matrix, and by performing Gram-Schmidt orthogonalization on the generated pseudo-random number matrix, a unitary matrix in which each column vector is orthogonal is generated. The generated unitary matrix is a random unitary matrix.

After step S303, the encryption execution unit 203a encrypts the observation vectors and the feature vectors using the map S and the random unitary matrix (step S304). More specifically, the encryption execution unit 203a encrypts the observation vectors and the feature vectors by using the matrix product of the map S and the random unitary matrix. For example, the y\hat{ }(k) hat and the X\hat{ }(k) hat are acquired, based on the Equations (49) and (50), at the k-th location.

After step S304, the encryption execution unit 203a acquires the column vectors not included in Q_{p, n tilde}S from among the column vectors of Q_{p, n tilde}, as complement column vectors of Q_{p, n tilde}S (step S305).

After step S305, the encryption execution unit 203a acquires either any one of the complement column vectors of Q_{p, n tilde}S, or the linear sum of the complement column vectors of Q_{p, n tilde}S, as ψ (step S306).

After step S306, the encryption execution unit 203a acquires the concealed observation vectors and the concealed feature matrices according to the Equations (68) and (70) (step S307).

The secure computation system 100 of the modified example thus configured includes the ciphertext generation apparatus 2 that increases the size of the information when encrypted analysis target information is generated using the analysis target information. Thus, the secure computation system 100 of the modified example thus configured is capable of enhancing the confidentiality of the analysis target information.

It is noted that ψ is an example of an orthogonal matrix, and the process of acquiring ψ (that is, the series of processes from step S305 to step S306) is an example of computing an orthogonal matrix. The processing in step S304 is an example of encrypting. The processing in step S302 is an example of acquiring a dimension extension map. The processing in step S303 is an example of acquiring a random unitary matrix.

The map S is an example of a dimension extension map. The regression execution unit 102 is an example of an analysis unit.

Other Methods that Enable Regression Process without Decryption

The method for performing the regression process without decryption is not limited to LASSO. The method for performing the regression process without decryption may be, for example, Elastic Net (see Reference Literature 3). The reason why the regression execution unit 102 is capable of performing regression analysis without decrypting the encrypted analysis target information will be described by taking as an example a case where the method of regression analysis is Elastic Net.
Reference Literature 3: J. Friedman, et al., “Regularization Paths for Generalized Linear Models via Coordinate Descent” Journal of Static Software, vol. 33, Issue. 1, 2010

Firstly, Elastic Net will be described by taking as an example a case where the analysis target information is not encrypted.

Elastic Net

Expressing an observation vector y by a linear sum of p number of feature vectors xⱼ will be considered. In the method called Elastic Net, the weighting coefficient vector is calculated as a solution of a constrained minimization problem of the following Expression (74).

$$\begin{matrix}[ Math . 74 ] & \\ {min}_{w ∈ {ℝ}^{p}} \frac{1}{2} {‖ y - Xw ‖}_{2}^{2} s . t . α {‖ w ‖}_{1} + ( 1 - α ) {‖ w ‖}_{2}^{2} \leq ω & ( 74 )\end{matrix}$$

Here, α represents the ratio of the terms of the L1 norm and the terms of the L2 norm in an expression expressing the constraint condition of the Expression (74). ω represents the strength of the constraint. More specifically, ω represents the range in which the values of the terms of the L1 norm and the terms of the L2 norm in the expression expressing the constraint condition of the Expression (74) can be included. The above-described constrained minimization problem can be formulated as a minimization problem represented by the following Expression (75) using the method of Lagrange multipliers.

$$\begin{matrix}[ Math . 75 ] & \\ {min}_{w ∈ {ℝ}^{p}} {L}_{Ela} ( w ) & ( 75 )\end{matrix}$$

$$\begin{matrix}[ Math . 76 ] & \\ {L}_{Ela} ( w ) {=}^{Δ} \frac{1}{2} {‖ y - Xw ‖}_{2}^{2} + ρα {‖ w ‖}_{1} + ρ ( 1 - α ) {‖ w ‖}_{2}^{2} = \frac{1}{2} {\sum }_{i = 0}^{n - 1} {( {y}_{i} - {\sum }_{j = 0}^{p - 1} {x}_{i , j} {w}_{j} )}^{2} + ρα {\sum }_{j = 0}^{p - 1} ‖ {w}_{j} ‖ + ρ ( 1 - α ) {\sum }_{j = 0}^{p - 1} {w}_{j}^{2} & ( 76 )\end{matrix}$$

Here, ρ is a Lagrange undetermined multiplier, which is a parameter determined with respect to the parameter ω. In the following discussion, for the sake of simplicity, it is assumed that the above-described Equations (6) and (7) are satisfied.

Elastic Net for Concealed Information

Next, the solution of the Expression (75) will be determined for the information subjected to transformation by the random unitary matrix Qp (random unitary transformation). Specifically, ω that minimizes the function represented by the following Expression (77) is acquired.

$$\begin{matrix}[ Math . 77 ] & \\ {\hat{L}}_{Ela} ( w ) {=}^{Δ} \frac{1}{2} {‖ \hat{y} - \hat{X} w ‖}_{2}^{2} + ρα {‖ w ‖}_{1} + ρ ( 1 - α ) {‖ w ‖}_{2}^{2} & ( 77 )\end{matrix}$$

The random unitary matrix Qp is a unitary matrix, because of which the relationship expressed b the following Equation (78) is actually satisfied.

$$\begin{matrix}[ Math . 78 ] \\ arg {min}_{w} \hat{L} ( w ) = arg {min}_{w} L ( w ) & \end{matrix} \qquad ( 78 )$$

The Equation (78) shows that the information acquired using Elastic Net, based on the information before the transformation by the random unitary matrix, and the information acquired using Elastic Net, based on the information after transformation by the random unitary matrix is the same. In this way, even if Elastic Net is used instead of LASSO, it is possible to analyze the analysis target event without decrypting the information encrypted by the random unitary matrix.

Distributed Concealment Using Elastic Net

In the explanation of Elastic Net provided so far, the properties of the random unitary matrix are the same as those used in LASSO. Thus, even when Elastic Net is used instead of LASSO when analyzing an analysis target event, the integrity of the solution holds for distributed concealment as well, similar to the case of LASSO. That is, the integrity of the Elastic Net solution that holds for random unitary transformation also holds for distributed concealment.

Confidentiality Enhancement Using Elastic Net

It has already been described that when the secure computation system 100 generates the encrypted analysis target information using the analysis target information, the size of the information may be increased, and in such a case, the secure computation system 100 executes the confidentiality enhancement process. The explanation of the confidentiality enhancement process so far has been provided by taking as an example a case of using LASSO. Here, the confidentiality enhancement process using Elastic Net (hereinafter, referred to as the “Elastic confidentiality enhancement process”) will be described.

For the sake of simplicity, the confidentiality enhancement process will be described by taking as an example a case where the size of the random unitary matrix Q_{p, n tilde} is n tilde rows by n tilde columns. When the random unitary matrix Q_{p, n tilde} is used for encryption in the Elastic confidentiality enhancement process, the concealed observation vector y tilde being the observation vector y after encryption is represented by the above-described Equation (68), as in the case of LASSO. However, unlike when LASSO is used, the concealed feature matrix X tilde being the feature matrix X after encryption, in the Elastic confidentiality enhancement process, is expressed by the following Equation (79) instead of the Equation (70).

[Math. 79]

\tilde{X}=Q_{p,ñ}SX+Φ (79)

The ψ in the Elastic confidentiality enhancement process is set as an n tilde dimensional vector satisfying the following Equations (80) to (82) instead of the Equation (73). Further, Φ is set as a matrix having n tilde rows and m columns satisfying the following Equations (80) to (82).

[Math. 80]

ψ^{T}(Q_{p,ñ}S)=0ₙ∈ [symbol] ⁿ (80)

[Math. 81]

Φ^{T}(Q_{p,ñ}S)=0_{m×n}∈ [symbol] ^{m×n} (81)

[Math. 82]

ψ^{T}Φ=0ₘ∈ [symbol] ^{m} (82)

0ₙ being the right side of the Equation (80) is an n-dimensional vector, where all elements are 0. 0_{m×n} being the right side of the Equation (81) is an m×n matrix, where all elements are 0. 0ₘ being the right side of the Equation (82) is an m-dimensional vector, where all elements are 0.

Thus, the Equation (80) represents that ψ is orthogonal to the column vector of the matrix represented by the following Expression (83).

[Math. 83]

(Q_{p,ñ}S) (83)

Further, the Equation (81) represents that the column vector of Φ is orthogonal to the column vector of the matrix represented by the Expression (83). Equation (82) represents that ψ is orthogonal to the column vector of Φ.

As described in the confidentiality enhancement process using LASSO, the map S is set as a matrix that satisfies the condition that elements of the matrix take a value of 0 or 1, the condition that the sum of the elements of each column is 1, and the condition that the sum of the elements of each row is 1 or 0. Thus, each column of the map S contains only one element being 1 and the other elements are 0. Further, the row that takes 1 in each column of the map S is different for each column. As a result of the transformation Sy using the S, an n tilde dimensional vector is obtained in which n out of n tilde elements are the same as the elements of y and the remaining elements are 0.

As for ψ, as explained in the confidentiality enhancement process using LASSO, ψ is configured by using the column vectors of Q_{p, n tilde}. Thus, Q_{p, n tilde}S is a matrix consisting of n number of column vectors. The n number of column vectors are the i(j) tilde-th column vectors (j=1, . . . , n) of Q_{p, n tilde}. Of the column vectors of Q_{p, n tilde}, there are (n tilde−n) number of column vectors not included in Q_{p, n tilde}S.

Q_{p, n tilde} is a unitary matrix, thus, the complement column vectors of Q_{p, n tilde}S are orthogonal to the column vectors of Q_{p, n tilde}S. Thus, by setting any one of the complement column vectors of Q_{p, n tilde}S as ψ, the condition represented by the Equation (80) being the condition required of ψ can be satisfied.

As for Φ, the Φ matrix is set as Φ. The Φ matrix is a matrix in which m number of complement column vectors from among the unused complement column vectors are set as column vectors. The unused complement column vectors are complement column vectors other than the complement column vectors set as φ among the complement column vectors of Q_{p, n tilde}S.

Such a Φ can satisfy the condition represented by the Equation (81) being the condition required of Φ, because the complement column vectors of Q_{p, n tilde}S are orthogonal to the column vectors of Q_{p, n tilde}S. Furthermore, the complement column vectors of Q_{p, n tilde}S are orthogonal to each other, and thus, the ψ and Φ thus configured satisfy the condition of the Equation (82) as well.

Here, the problem of minimizing the function represented by the following Expression (84) will be considered.

$$\begin{matrix}[ Math . 84 ] & \\ {\tilde{L}}_{Ela} ( w ) {=}^{Δ} \frac{1}{2} {‖ \tilde{y} - \tilde{X} w ‖}_{2}^{2} + ρα {‖ w ‖}_{1} + ( ρ ( 1 - α ) - \frac{1}{2} ) {‖ w ‖}_{2}^{2} & ( 84 )\end{matrix}$$

Using the following Identity (85), the Expression (84) is transformed into the following Equation (86):

$$\begin{matrix}[ Math . 85 ] & \\ {‖ \tilde{y} - \tilde{X} w ‖}_{2}^{2} = {‖ y - Xw ‖}_{2}^{2} + {‖ w ‖}_{2}^{2} + {‖ ψ ‖}_{2}^{2} & ( 85 )\end{matrix}$$

$$\begin{matrix}[ Math . 86 ] & \\ {\tilde{L}}_{Ela} ( w ) = {‖ y - Xw ‖}_{2}^{2} + ρα {‖ w ‖}_{1} + ρ ( 1 - α ) {‖ w ‖}_{2}^{2} + \frac{1}{2} {‖ ψ ‖}_{2}^{2} = {L}_{Ela} ( w ) + \frac{1}{2} {‖ ψ ‖}_{2}^{2} & ( 86 )\end{matrix}$$

Thus, the relationship of the following Equation (87) is satisfied.

$$\begin{matrix}[ Math . 87 ] & \\ arg {min}_{w} \tilde{L} ( w ) = arg {min}_{w} L ( w ) & ( 87 )\end{matrix}$$

The Equation (87) shows that the information acquired using Elastic Net, based on the information before the transformation by the random unitary matrix represented by the Equations (68) and (79), and the information acquired using Elastic Net, based on the information after transformation by the random unitary matrix represented by the Equations (68) and (79) is the same.

Thus, by calculating a solution that minimizes the value on the left side of the Equation (87) with respect to the information after transformation by the random unitary matrix represented by the Equations (68) and (79), it is possible to calculate the Elastic Net solution for the information before the transformation by the random unitary matrix represented by the Equations (68) and (79). In this way, even if Elastic Net is used instead of LASSO, it is possible to analyze the analysis target event without decrypting the information encrypted by the random unitary matrix.

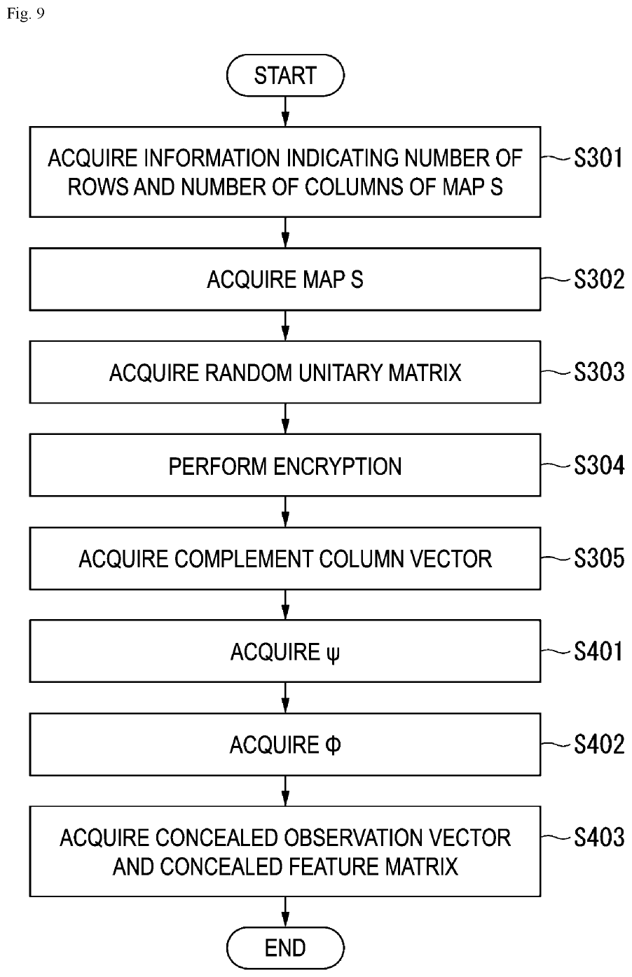

Hereinafter, an example of the flow of the Elastic confidentiality enhancement process executed by the ciphertext generation apparatus 2 in the modified example will be described, with reference to FIG. 9, by taking as an example a case where the secure computation system 100 includes K number (K is a natural number) of ciphertext generation apparatuses 2. Hereinafter, for the sake of simplicity, an example of the flow of the Elastic confidentiality enhancement process will be described by taking as an example a case where the dimension of the observation vector after extension by the map S is n tilde.

FIG. 9 is a flowchart illustrating an example of a flow of processing for the execution of an Elastic confidentiality enhancement process by the ciphertext generation apparatus 2 in the modified example. Hereinafter, for the sake of simplicity, the same reference signs as those in FIG. 8 will be applied to the processing similar to the processing illustrated in FIG. 8, and description thereof will be omitted.

The processing in steps S301 to S305 is executed. After step S305, the encryption execution unit 203a acquires any one of the complement column vectors of Q_{p, n tilde}S as ψ (step S401). Next, the encryption execution unit 203a sets the Φ matrix as Φ (step S402). In step S402, the unused complement column vectors are complement column vectors other than the complement column vector acquired as φ in step S401 among the complement column vectors of Q_{p, n tilde}S. After step S402, the encryption execution unit 203a acquires the concealed observation vectors and the concealed feature matrices according to the Equations (68) and (79) (step S403).

The secure computation system 100 of the modified example thus configured includes the ciphertext generation apparatus 2 that increases the size of the information by the Elastic confidentiality enhancement process, when encrypted analysis target information is generated using the analysis target information. Thus, the secure computation system 100 thus configured is capable of enhancing the confidentiality of the analysis target information.

Even when ψ is set as the linear sum of the complement column vectors of the complement column vectors of Q_{p, n tilde}S, the condition represented by the Equation (80) being the condition required of ψ can be satisfied. Thus, in step S401, the encryption execution unit 203a may acquire the linear sum of the complement column vectors of Q_{p, n tilde}S as ψ.

This ends the description of other methods that enable the regression process without decryption.

Each of the secure computation apparatus 1, the ciphertext generation apparatus 2, and the management apparatus 3 may be implemented using a plurality of information processing apparatuses communicably connected via a network. In this case, each functional unit included in each of the secure computation apparatus 1, the ciphertext generation apparatus 2, and the management apparatus 3 may be distributed and implemented in a plurality of information processing apparatuses.

Note that all or some functions of the secure computation apparatus 1, the ciphertext generation apparatus 2, and the management apparatus 3 may be realized using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disk, a ROM, or a CD-ROM, or a storage device such as a hard disk drive incorporated in a computer system. The program may be transmitted via an electrical communication line.

Although the embodiment of the present invention has been described in detail with reference to the drawings, a specific configuration is not limited to the embodiment, and a design or the like in a range that does not depart from the gist of the present invention is included.

### REFERENCE SIGNS LIST

100 Secure computation system
1 Secure computation apparatus
2 Ciphertext generation apparatus
3 Management apparatus
10 Control unit
11 Communication unit
12 Storage unit
13 User interface
20, 20a Control unit
21 Communication unit
22 Storage unit
23 User interface
30 Control unit
31 Communication unit
32 Storage unit
101 Encrypted information acquisition unit
102 Regression execution unit
103 Communication control unit
104 Recording unit
105 Output control unit
201 Analysis target information acquisition unit
202, 202a Random unitary matrix generation unit
203, 203a Encryption execution unit
204 Communication control unit
205 Recording unit
206 Map acquisition unit

1. A secure computation method, comprising:
acquiring a plurality of pieces of encrypted analysis target information being a plurality of pieces of encrypted information about an event to be analyzed; and
analyzing, based on the plurality of pieces of the encrypted analysis target information, the event without decrypting the plurality of pieces of the encrypted analysis target information, wherein
encryption keys for the plurality of pieces of the encrypted analysis target information are unitary matrices, and
at least one of the encryption keys for the plurality of pieces of the encrypted analysis target information is different from another of the encryption keys.

2. The secure computation method according to claim 1, wherein
a block diagonal matrix having a plurality of the encryption keys as diagonal elements is a unitary matrix.

3. A secure computation method, comprising:
acquiring a dimension extension map for extending a dimension of a vector representing analysis target information being information about an event to be analyzed;
acquiring a random unitary matrix having the same number of rows and the same number of columns as the dimension of the vector after extension by the dimension extension map; and
encrypting the vector by the dimension extension map and the random unitary matrix, wherein
the acquiring of the dimension extension map is executed to improve an encryption strength of the vector encrypted in the encrypting.

4. The secure computation method according to claim 3, further comprising:
computing an orthogonal matrix of the random unitary matrix, wherein
the encrypting includes encrypting the analysis target information by calculating a matrix product of the dimension extension map and the orthogonal matrix.

5. A secure computation system, comprising:
a processor; and
a storage medium having computer program instructions stored thereon, when executed by the processor, perform to:
acquire a plurality of pieces of encrypted analysis target information being a plurality of pieces of information encrypted in advance and being information about an event to be analyzed; and
analyze, based on the plurality of pieces of the encrypted analysis target information, the event without decrypting the plurality of pieces of the encrypted analysis target information, wherein
encryption keys for the plurality of pieces of the encrypted analysis target information are unitary matrices, and
at least one of the encryption keys for the plurality of pieces of the encrypted analysis target information is different from another of the encryption keys.

6. (canceled)

7. A non-transitory computer-readable medium having computer-executable instructions that, upon execution of the instructions by a processor of a computer, cause the computer to function as the secure computation system according to claim 5.

8. The secure computation method according to claim 1, wherein
the event is analyzed by using Elastic Net in the analyzing.
